(19) United States
(12) Patent Application Publication
(10) Pub. No.: US 2009/0014453 A1
(43) Pub. Date: Jan. 15, 2009

(54) COLLAR FOR MOUNTING A PROTECTIVE CAP AND ASSEMBLY FOR STORAGE AND DELIVERY OF A GAS COMPRISING SUCH A COLLAR

(76) Inventors: Christian Bleys, Livry Sur Seine (FR); Philippe Deck, Montreuil (FR); Fabrice Pin, Viroflay (FR)

Correspondence Address: AIR LIQUIDE;Intellectual Property, 2700 POST OAK BOULEVARD, SUITE 1800, HOUSTON, TX, 77056, US

(21) Appl. No.: 11/971,049

(22) Filed: Jan. 8, 2008

(30) Foreign Application Priority Data
Jan. 8, 2007 (FR) 0752563

(51) Int. Cl. F17C 13/06; F17C 1/00

(52) U.S. Cl. 220/581; 220/727; 137/382

(57) ABSTRACT

Collar for mounting a valve protection bonnet or cap on a fluid cylinder, characterized in that it comprises a first mounting portion provided with first fixing elements (2) intended to collaborate in removable attachment with a mating fixing region belonging to a valve, a second mounting portion provided with second fixing elements (3) intended to collaborate in removable attachment with a mating fixing region belonging to a protective cap, and a third mounting portion provided with bearing elements (4) intended to collaborate with an accepting region on the exterior surface of a body of the cylinder.

The present invention relates to an assembly for storing and delivering gas that comprises such a collar.

This application claims the benefit of priority under 35 U.S.C. § 119 (a) and (b) to French Patent Application No. FR 0752563, filed Jan. 8, 2007 the entire contents of which are incorporated herein by reference.

The present invention relates more specifically to an assembly for storing and delivering fluid under pressure, comprising a pressurized fluid cylinder, a valve mounted on an orifice of the cylinder and a control protection cap.

Gas cylinders traditionally consist of a cylinder barrel (that is to say the cylinder itself), a valve or built-in valve/regulator and a plastic and/or metal cap.

The cap protects the valve if the cylinder is dropped or knocked over onto the ground in order to prevent dangerous damage to and/or cracking of the valve.

In this application, the term “valve” will be used to denote any kind of member used to control the flow rate of fluid, particularly so-called “simple” valves as well as valves with a built-in regulator.

The way in which a protective cap is mounted on a cylinder differs according to whether or not the cylinder has a narrowed neck formed as an integral part of the remainder of the cylinder (also known as a collar).

When the cylinder has a neck, the protective cap and the valve are each fixed directly to the neck independently of one another. When this is done, the valve is secured to and sealed against the cylinder by applying a very high torque when tightening the valve. In addition, in such cases, the neck geometry can vary from one cylinder to another, which means that a specific (dedicated) cap needs to be provided for each type of neck.

When the cylinder has no neck (no narrowed cylindrical portion around the orifice for mounting the cap), the protective cap is fixed to the valve, the valve being itself screwed onto the cylinder. In such cases, if the cap is knocked, the forces are then transmitted in full to the valve via its own screw thread. This increases the risk of valve breakage, particularly if the diameter of the screw thread is small. This configuration therefore increases the risk of the valve becoming unscrewed and leaking.

It is an object of the invention to propose an architecture that lessens all or some of the disadvantages of the prior art.

The proposed solution is to use an attached mounting collar.

The assembly, in other respects in accordance with the above preamble, is essentially characterized in that it comprises a mounting collar comprising a first mounting portion provided with first fixing elements collaborating in removable attachment with a mating fixing region belonging to a valve, a second mounting portion provided with second fixing elements collaborating in removable attachment with a mating fixing region belonging to the protective cap, and a third mounting portion provided with bearing elements collaborating with an accepting region on the exterior surface of the body of the cylinder, the first fixing elements of the collar being fixed to the valve, the protective cap being fixed to the second fixing elements of the collar and the bearing elements of the collar bearing against the exterior surface of the upper part of the cylinder.

Furthermore, the invention may have one or more of the following features:
the collar has the overall shape of a frustoconical tube,
the first fixing elements, the second fixing elements and the bearing elements are positioned in succession in this order at separate heights between an upper extremity and a lower extremity of the collar,
the first fixing elements comprise at least one of the following elements: a tapped thread, a system of attachment employing elastic deformation, a projecting or recessed interlocking piece,
the first mounting portion provided with first fixing elements is formed on an interior and substantially cylindrical surface of the collar,
the second fixing elements comprise at least one of the following elements: a screw thread, a system of attachment employing elastic deformation, a projecting or recessed interlocking piece,
the second mounting portion provided with second fixing elements is formed on an exterior and substantially cylindrical surface of the collar,
the bearing elements comprise a surface of revolution positioned about a vertical axis of the collar, the surface of revolution being continuous or consisting of a plurality of elementary surfaces,
the surface of revolution is formed by a circular extremity of the skirt-shaped lower portion of the collar,
the collar is made of plastic and/or of metal,
the collar is perforated, that is to say has one or more apertures formed between the second fixing elements and the bearing elements,
the first fixing elements of the collar are screw-fastened to a threaded lower part of the valve.

According to an advantageous specific feature, the first fixing elements of the collar are fixed to the valve, the protective cap being fixed to the second fixing elements of the collar and the bearing elements of the collar bearing against the exterior surface of the upper part of the cylinder.

Other features and advantages of the invention will become better apparent from reading the description hereinbelow, which is given with reference to the figures in which:

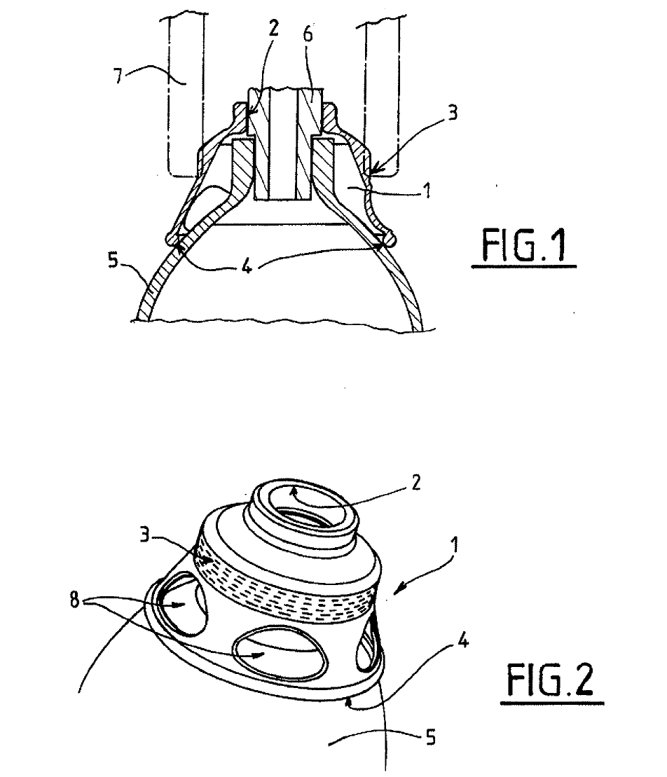

FIG. 1 depicts a schematic and partial sectioned view illustrating a detail of an assembly for storing and delivering fluid under pressure according to one exemplary embodiment of the invention,

FIG. 2 depicts a perspective view of part of the storage and delivery assembly of FIG. 1.

With reference to FIGS. 1 and 2, the assembly for storing and delivering fluid under pressure comprises a pressurized fluid cylinder 5, a valve 6 and a protective cap 7.

For the purposes of simplicity, only the upper part of the cylinder 5 and the threaded lower base of the valve 6 have been depicted. Likewise, only the lower part of the cap 7 is depicted schematically in FIG. 1.

The collar 1 has the overall shape of a frustoconical tube substantially of revolution the upper extremity of which has a tapped cylindrical portion 2 into which a threaded portion of the lower part of the valve 6 is screwed. The lower extremity of the collar 1 forms a skirt that widens towards the bottom and the end of which bears against the convergent upper portion of the upper extremity of the cylinder 5.

The middle part of the collar 1 comprises, on its exterior surface, a threaded substantially cylindrical portion onto which a mating tapped thread belonging to the base of the protective cap 7 is screwed.

As depicted, the widening bottom portion of the collar may have openings 8 or apertures.

The attached mounting collar 1 allows one and the same protective cap 7 to be mounted with equal ease either on cylinders that have a neck (like the one depicted in FIG. 1) or cylinders that have no neck. In the latter instance, the cap is also fixed to the valve and bears against the surface of the cylinder 5.

Furthermore, the attached collar 1 can fit varying cylinder shoulder profiles, thus allowing the same cap to be mounted on a wide variety of cylinder geometries.

In the example depicted, the attached collar 1 is screwed onto the bottom of the valve 6 although as an alternative it is possible to conceive of any other method of fixing or of attachment such as a clip, an interlocking with the valve or the like.

The collar 1 may be made as a single piece or in several assembled parts and may be made of metal or injection-moulded plastic, allowing it to be produced at a very low cost of manufacture.

The collar 1 allows at least some of the forces to be transferred to the cylinder if dropped, rather than these forces being applied only to the valve. This is particularly advantageous in the case of a cylinder that has no neck.

The safety of the assembly is thus improved.

Furthermore, the collar 1 forms a locknut for the valve 6 screwed onto the cylinder, preventing unwanted unscrewing of the valve relative to the cylinder. This allows the valve to be screwed into the cylinder using a tightening torque that is lower than in known arrangements.

The solution according to the invention, while being of simple and inexpensive structure, thus makes it easier to mount a cap on a cylinder and improves the reliability and therefore the safety thereof.

Furthermore, the proposed solution has a small impact on the design of the valve or of the built-in valve/regulator (all that is required is the provision of mating fixing means intended to collaborate with the upper portion of the collar).

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. An assembly for storing and delivering fluid under pressure, comprising a pressurized fluid cylinder, a valve mounted on an orifice of the cylinder and a control protection cap, wherein said assembly comprises a mounting collar comprising a first mounting portion provided with first fixing elements collaborating in removable attachment with a mating fixing region belonging to a valve, a second mounting portion provided with second fixing elements collaborating in removable attachment with a mating fixing region belonging to the protective cap, and a third mounting portion provided with bearing elements collaborating with an accepting region on the exterior surface of the body of the cylinder, the first fixing elements of the collar being fixed to the valve, the protective cap being fixed to the second fixing elements of the collar and the bearing elements of the collar bearing against the exterior surface of the upper part of the cylinder.

2. The assembly of claim 1, wherein the collar has the overall shape of a frustoconical tube.

3. The assembly of claim 1, wherein the first fixing elements, the second fixing elements and the bearing elements are positioned in succession in this order at separate heights between an upper extremity and a lower extremity of the collar.

4. The assembly of claim 1, wherein the first fixing elements comprise at least one of the following elements: a tapped thread, a system of attachment employing elastic deformation, a projecting or recessed interlocking piece.

5. The assembly of claim 1, wherein the first mounting portion provided with first fixing elements (s formed on an interior and substantially cylindrical surface of the collar.

6. The assembly of claim 1, wherein the second fixing elements comprise at least one of the following elements: a screw thread, a system of attachment employing elastic deformation, a projecting or recessed interlocking piece.

7. The assembly of claim 1, wherein the second mounting portion provided with second fixing elements is formed on an exterior and substantially cylindrical surface of the collar.

8. The assembly of claim 1, wherein the bearing elements comprise a surface of revolution positioned about a vertical axis of the collar, the surface of revolution being continuous or consisting of a plurality of elementary surfaces.

9. The assembly of claim 8, wherein the surface of revolution is formed by a circular extremity of the skirt-shaped lower portion of the collar.

10. The assembly of claim 1, wherein the collar is made of plastic and/or of metal.
